(19) United States
(12) Patent Application Publication
(10) Pub. No.: US 2011/0145733 A1
(43) Pub. Date: Jun. 16, 2011

(54) MULTI-PAGE ORGANIZING AND MANIPULATING ELECTRONIC DOCUMENTS

(75) Inventors: Jonathan Neitz, Calgary (CA); Miaosen Wang, Calgary (CA); Giselle Goncalves, Calgary (CA); Stewart Schneider, Calgary (CA); Michael Boyle, Calgary (CA)

(73) Assignee: Smart Technologies Ulc, Calgary (CA)

(21) Appl. No.: 12/812,220

(22) PCT Filed: Jan. 8, 2009
(86) PCT No.: PCT/CA09/00012

§ 371 Date: Feb. 1, 2011

Related U.S. Application Data
(60) Provisional application No. 61/020,062, filed on Jan. 9, 2008.

(51) Int. Cl. G06F 3/048

(52) U.S. Cl. 715/761

(57) ABSTRACT

A software tool for organizing and manipulating an electronic document comprising at least one group of document pages, comprises a first user interface module configured to present the document pages of the electronic document in a list-like arrangement; a second user interface module configured to present the document pages of each group in a respective panel; and means operable to manipulate a plurality of selected document pages presented in one or more of the panels simultaneously.

### FIELD OF THE INVENTION

The present invention relates generally to document management and in particular, to a method and tool for organizing and manipulating electronic documents.

### BACKGROUND OF THE INVENTION

The model-view-controller (MVC) is a common architectural pattern used in software engineering that it is typically employed in complex software applications that present large amounts of data and maintain multiple views of the same data. The MVC architecture separates objects into one of three categories, namely models, views and controllers. In the MVC architecture, models are responsible for maintaining data, views are responsible for the user interfaces that display all or a portion of the data and controllers are responsible for handling events that affect the models or views. By separating objects in this manner, multiple views and controllers can interact with the same models. New views and controllers can also be created to interact with models without requiring changes in the model designs. Also, separating the objects in this manner allows changes in the views and hence, changes in the user interfaces to be made without affecting data handling and allows models to be reorganized without requiring changes in the views.

The Notebook™ software offered by SMART Technologies ULC of Calgary, Alberta, Canada, assignee of the subject application is a software product employing the MVC architecture. SMART Notebook™ allows users to create, organize and manipulate documents, with each document comprising one or more pages. Turning now to FIG. 1, the MVC architecture of SMART Notebook™ is shown and is generally identified by reference numeral 20. As can be seen, the SMART Notebook™ MVC architecture 20 comprises models 22, in this case a PageModel and a PageListModel, a view 24, in this case a PageSorter, and a controller 26, in this case a PageListController. The PageModel is the data representation of a document page and provides methods to manipulate the document page. The PageListModel is the data representation of the list of pages making up a document. The PageListController handles the events that permit manipulation of the PageListModel. The PageSorter provides the user interface that allows pages of a document to be selected and manipulated. In particular, for a selected document the PageSorter user interface displays the selected document page in a main viewing area or window and displays the other pages of the document as thumbnails (e.g. small replica images) along the left or right side of the main viewing area. In response to user input received as a result of user interaction with the PageSorter user interface, the PageSorter relays the user input to the PageListController. The PageListController in response sets the state of the PageModel and PageListModel and returns a notification to the PageSorter. The PageSorter in response to the notification queries the state of the PageModel and PageListModel and updates the user interface accordingly.

Although SMART Notebook™ has proven to be a valuable tool for organizing pages of a document, the PageSorter provides limited document manipulation facilities. In particular, adding, moving or deleting pages of a document can only be performed through user interaction with the PageSorter and only a single page can be manipulated at a time. As will be appreciated improvements in document manipulation are desired.

It is therefore an object of the present invention to provide a novel method and tool for organizing and manipulating electronic documents.

### SUMMARY OF THE INVENTION

Accordingly, in one aspect there is provided a software tool for organizing and manipulating an electronic document comprising at least one group of document pages, said software tool comprising a first user interface module configured to present the document pages of the electronic document in a list-like arrangement; a second user interface module configured to present the document pages of each group in a respective panel; and means operable to manipulate a plurality of selected document pages presented in one or more of said panels simultaneously.

In one embodiment, the second user interface module is configured to permit document pages of each group to be re-ordered within the respective panel.

The re-ordering may be performed via drag and drop operations. The second user interface module is also configured to permit document pages to be moved between panels via drag and drop operations. In one embodiment, the first user interface module is configured to permit the order of document pages in the list-like arrangement to be re-ordered. The means operable to manipulate is configured to apply a theme such as a color, graphical objects, text, pattern, audio, video etc. to the plurality of selected document pages.

According to another aspect there is provided in a presentation software environment where presentation software that permits a document comprising a plurality of pages to be displayed and manipulated when executing on a computing device, the improvement comprising a grouping tool operable to group pages of the document and display the pages of each group and to manipulate selected pages of one or more groups.

According to yet another aspect there is provided an electronic document organization and manipulation method comprising displaying each group of electronic pages of a document in an individual panel on a graphical user interface; providing a tool to allow a user to re-order pages in one or more panels and/or to move pages between panels; and responsive to use of the tool, re-ordering and/or moving the pages appropriately.

According to yet another aspect there is provided a computer readable medium embodying a computer program for organizing and manipulating an electronic document comprising at least one group of document pages, said computer program comprising computer program code for presenting the document pages of the electronic document in a list-like arrangement; computer program code for presenting the document pages of each group in a respective panel; and computer program code for manipulating a plurality of selected document pages presented in one or more of said panels simultaneously.

According to still yet another aspect there is provided a computer readable medium embodying a computer program for organizing and manipulating an electronic document, said computer program comprising computer program code for displaying each group of electronic pages of a document in an individual panel on a graphical user interface; and computer program code responsive to user input for re-ordering pages in panels and/or moving pages between panels.

### BRIEF DESCRIPTION OF THE DRAWINGS

Embodiments will now be described more fully with reference to the accompanying drawings in which:

FIG. 1 is a representation of the prior art SMART Notebook™ MVC architecture;

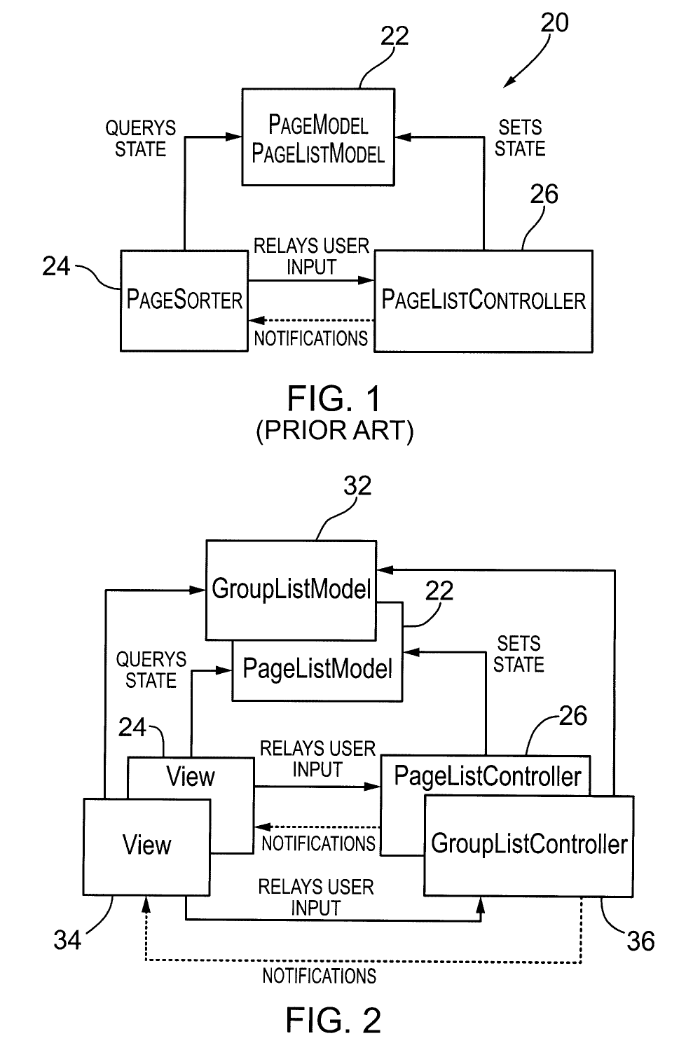

FIGS. 2 and 3 are representations of an additional MVC architecture overlying the SMART Notebook™ MVC architecture;

FIG. 4 shows a PageGroupView user interface;

FIG. 5 shows a drop down menu on the PageGroupView user interface;

FIG. 6 shows an augmented PageSorter user interface; and

FIG. 7 shows a drop down menu on the augmented PageSorter user interface.

### DETAILED DESCRIPTION OF THE EMBODIMENTS

As mentioned above, SMART Notebook™ software offered by SMART Technologies ULC of Calgary, Alberta, Canada is a software product employing the MVC architecture. SMART Notebook™ allows users to create, organize and manipulate documents, with each document comprising one or more pages. To enhance the ability of SMART Notebook™ to organize and manipulate pages of documents, a PageGrouping tool is provided. The PageGrouping tool allows a user to manipulate multiple pages of a document simultaneously in a manner that enables multiple pages to be logically associated with a category in meaningful ways determined by the user.

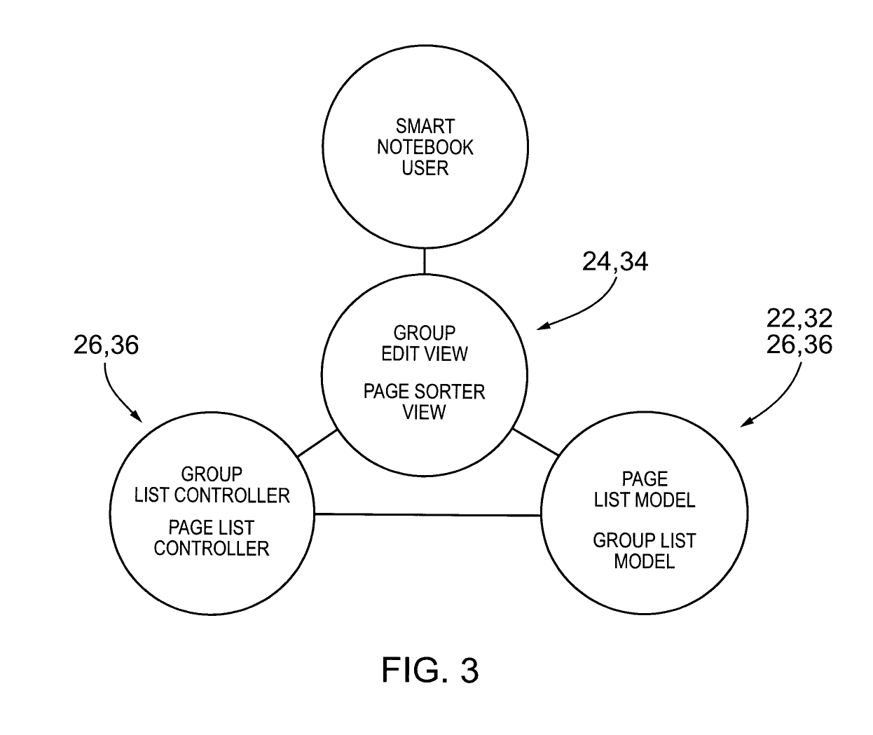

The PageGrouping tool is realized by overlying the SMART Notebook™ MVC architecture 20 with additional MVC architecture 30 that mirrors the MVC architecture 20, as shown in FIGS. 2 and 3. The additional MVC architecture 30 comprises models 32, in this example a GroupModel and a GroupListModel, views 34, in this example an augmented PageSorter and a PageGroupView and controllers 36, in this example a GroupListController.

The GroupModel is the data representation of a group of pages of a document and mirrors the functionality of the PageModel by providing methods to manipulate a representation of the group of document pages. For each group of document pages, the GroupModel stores group specific data such as the group title, the group ID, the number of document pages in the group and the document page indexes in the group. Appendix A shows an exemplary representation of the GroupModel. As will be appreciated, the GroupModel allows document pages to be added to a group, removed from a group or deleted from a group and allows the title of a group of document pages to be set. The GroupModel does not store pages of the document. Rather, the GroupModel stores unique identifiers (e.g. the page IDs) identifying the document pages of the group.

The GroupListModel is the data representation of a list of the groups of pages of a document and is analogous to the PageListModel. In particular, the GroupListModel stores information regarding the order of the groups of pages in the document. The GroupListModel provides methods to organize groups of document pages, add groups of document pages, rearrange groups of document pages and delete groups of document pages. The GroupListModel also provides a method for creating a virtual group of document pages comprising an amalgamation of all groups of document pages currently in the GroupListModel. Appendix B shows an exemplary representation of the GroupListModel.

The GroupListController is the controller that handles the events to permit manipulation of the GroupListModel. Appendix C shows an exemplary representation of the GroupListController. The GroupListController maintains the separation between models 32 and views 34 as well provides a mechanism to synchronize and distribute application notification messages. For example, calling the AddGroup function does not only add a new GROUP_ID to the GroupListModel but also notifies the relevant views that the GroupListModel has changed so the views can update accordingly.

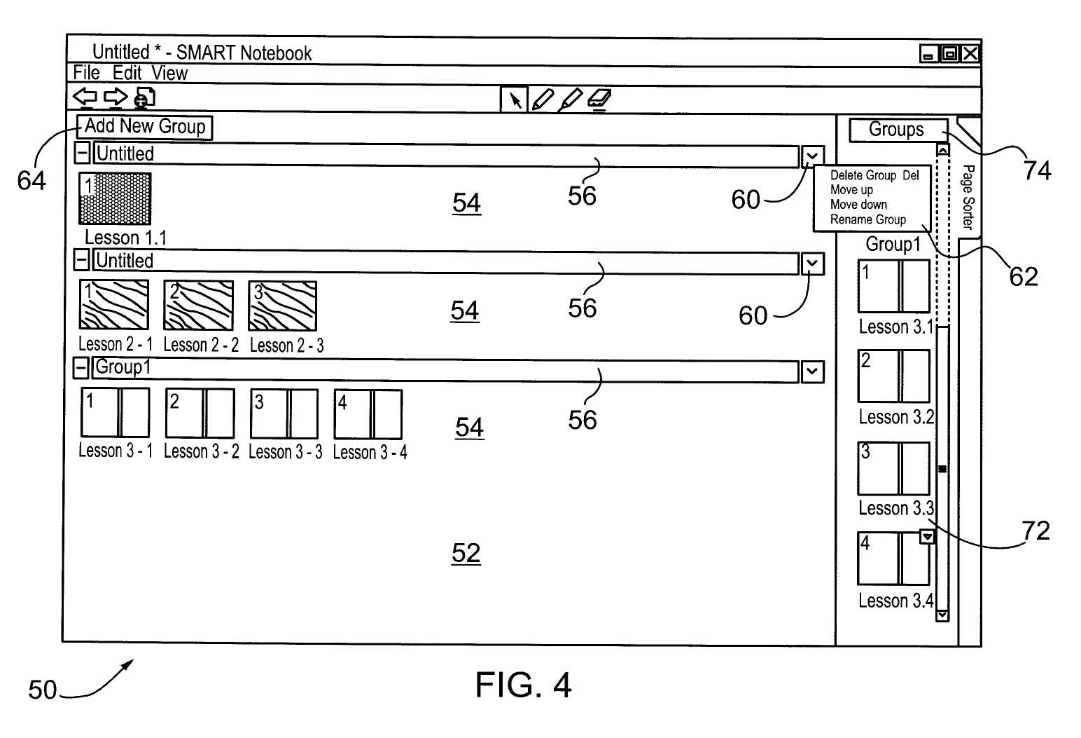

The PageGroupView provides the user interface 50 that is used to manipulate groups of document pages as can be seen in FIG. 4. The PageGroupView user interface 50 provides an intuitive way to manage pages of a document and pages in groups within the document via drag and drop operations. In particular, the PageGroupView user interface 50 presents the document pages of each of the groups of a document in a main viewing area 52. The document pages of each group are presented as an array in a panel 54 under a title bar 56 that identifies the title assigned to the group. Each document page within each group can be re-ordered simply by selecting the desired document page, dragging the selected document page across the panel 54 to its new desired location in the group and releasing the selected document page. Each document page can also be moved from one group to another by selecting the desired document page of one group, dragging the selected document page across one or more panels 54 to its desired location in the new group and releasing the selected document page. A selectable button 60 is provided adjacent the right end of each title bar 56 that when selected exposes a menu 62 of selectable operations that enable the group associated with the title bar to be selected, moved or renamed. An “add new group” selectable button 64 is also provided that when selected allows a new group of document pages to be created and a corresponding panel 54 and title bar 56 displayed. Once the panel 54 and title bar 56 have been displayed, document pages can then be dragged from the panels 54 of existing groups and dropped in the new panel 54 under the title bar 56 as described above. The PageGroupView user interface 50 also allows a document page property, such as for example a background theme (e.g. color, graphical objects, text, pattern (striping, hatching etc.), audio, video etc.), to be applied to one or more selected groups of document pages. In this manner, multiple document pages of one or more selected groups can be manipulated simultaneously.

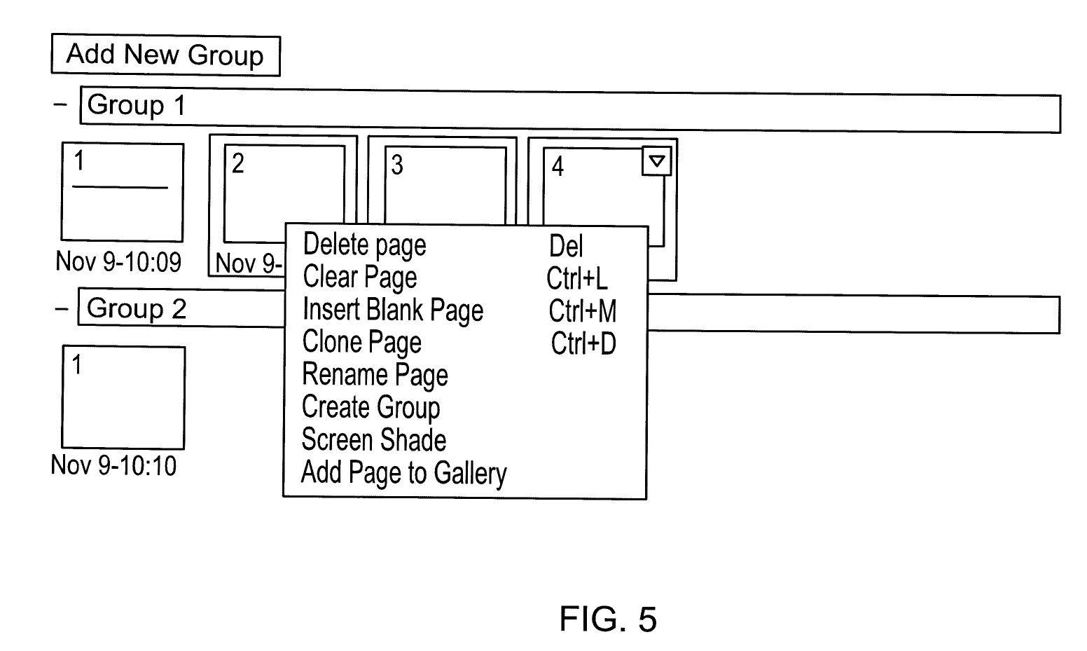

A new group of document pages can also be created by selecting document pages within an existing group and performing a right-click event, which results in the display of a menu comprising delete page, clean page, create group and screen shade options as shown in FIG. 5. Selecting the create group option from the menu creates a panel 54 and title bar 56 for the new group and places the selected document pages in the panel 54 created for the new group. Selecting the screen shade option allows the user to choose a background theme for the selected document pages.

The PageGroupView is separated into a rendering component and a native graphical user interface component allowing the underlying layout, behavior and look and feel of the PageGroupView to be used across various versions of SMART Notebook™. Appendix D shows an exemplary representation of the rendering component of the PageGroupView. As will be appreciated, the rendering component of the PageGroupView comprises an IPageGroupView class and a CPageGroupView class. The IPageGroupView class is a callback interface that is used by the rendering component to communicate with the native graphical user interface component. The native graphical user interface component responds to callbacks as well as calls into the CPageGroupView class to handle behavior, drag and drop, rendering, keyboard and mouse input.

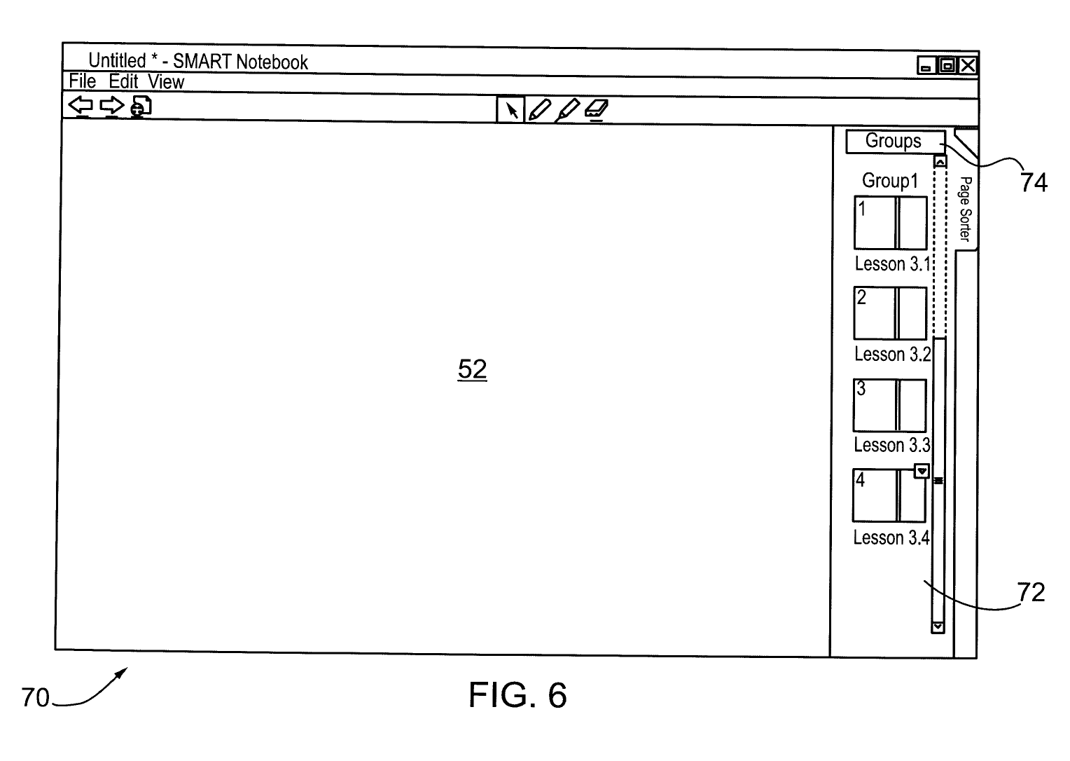

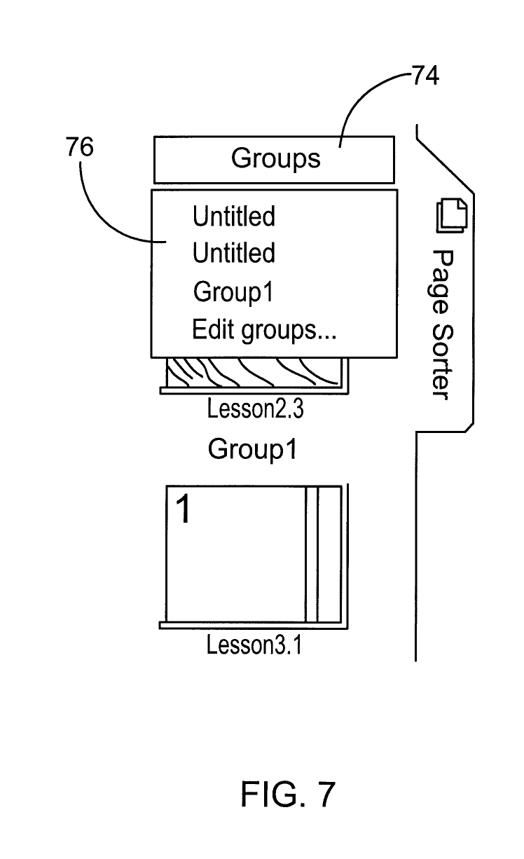

The augmented PageSorter provides the user interface 70 that is used for navigation between groups of document pages and for selecting a current document page for display on the main viewing area 52 as shown in FIG. 6. As can be seen, the augmented PageSorter user interface 70 presents a list 72 of thumbnails to one side of the main viewing area 52 that can be used to navigate through the pages of a document. Document pages of each group are presented in order in the list. Selecting a thumbnail presented in the list 72 switches the main viewing area 52 to the document page corresponding to the selected thumbnail. The PageSorter user interface 70 permits the drag and drop of document pages in the list either within a group or between groups, scrolling to a specific group of document pages, and operations to be applied to multiple selected document pages. The PageSorter user interface 70 comprises a selectable “Group” button that when selected exposes a drop down menu 76 as shown in FIG. 7. The menu 76 identifies each of the groups of document pages by title. Selecting a title scrolls the list 72 of displayed thumbnails so that the thumbnail representations of the document pages of the group corresponding to the selected title are at the top of the list. The menu 76 also comprises a group edit item that when selected exposes a menu of selectable operations that enable document pages to be moved between groups, document pages within groups to the re-ordered, groups of pages within the document to be re-ordered and groups of document pages to be renamed.

Although the PageGrouping tool has been described with specific reference to its implementation in SMART Notebook™, those of skill in the art will appreciate that the PageGrouping tool may be used in other presentation software environments to facilitate the management of electronic documents (e.g. files or pages) by permitting the electronic documents to be grouped as desired and the groups of electronic documents to be manipulated as desired.

The PageGrouping tool is advantageous in that it enables a user to categorize, manipulate and easily access groups of pages in a document. This is particularly beneficial in situations where a large number of documents, each containing a large number of pages are maintained. The PageGrouping tool has proven to be very useful in the educational environment in that it allows teachers to organize and structure lesson plans. For example, a book can be represented by a document with each group within the document representing the chapters of that book. This allows teachers to plan lessons around several chapters (i.e. groups) with the ability to jump between different chapters using the PageGroupView and PageSorter user interfaces during a class. Notes for the class can also be provided as document pages in groups. Another similar use is to organize a particular class lesson around several topics to be discussed during the class and creating a document that includes groups of document pages representing the topics for discussion. Document pages of a group that are not discussed during the lesson can of course be moved to the document representing the next class lesson through the user interface.

The PageGrouping tool may comprise program modules including but not limited to routines, programs, object components, data structures etc. and may be embodied as computer readable program code stored on a computer readable medium. The computer readable medium is any data storage device that can store data, which can thereafter be read by a computer system. Examples of computer readable medium include for example read-only memory, random-access memory, CD-ROMs, magnetic tape and optical data storage devices. The computer readable program code can also be distributed over a network including coupled computer systems so that the computer readable program code is stored and executed in a distributed fashion.

Although embodiments have been described with reference to the drawings, those of skill in the art will appreciate that variations and modifications may be made without departing from the spirit and scope thereof as defined by the appended claims.

APPENDIX A
class IGroupModel
{

protected:

virtual ~IGroupModel( ) { };

public:

virtual void AddPage(PAGE_ID id, UINT
index=OxFFFFFFFF) = 0;
virtual void RemovePage(PAGE_ID id) = 0;
virtual void MovePage(PAGE_ID id, UINT index) = 0;
virtual GROUP_ID GetUniqueGrouplD( ) const = 0;
virtual void SetTitle(const CAtlString & title) = 0;
virtual CAtlString GetTitle( ) const = 0;
virtual void AddPageList( CAtlArray<PAGE_ID> & ids ) = 0;
virtual void GetPageIDs( CAtlArray<PAGE_ID> & ids ) = 0;
virtual int GetDisplayIndex( PAGE_ID id ) = 0;
virtual PAGE_ID GetIDFromIndex(UINT index) = 0;
virtual UINT GetNumber0fPages( ) const = 0;

};
typedef boost::shared_ptr<IGroupModel> IGroupModelPtr

APPENDIX B
class IGroupListModel
{
protected:

virtual -IGroupListModel( ) { };

public:

virtual GROUP_ID AddGroup( UINT index = OxFFFFFFFF ) = 0;
virtual void DeleteGroup( GROUP_ID id ) = 0;
virtual void MoveGroup( GROUP_ID id, UINT newIndex ) = 0;
virtual void RestoreExistingGroup( GROUP_ID id, UINT
iInsertionIndex ) = 0;
virtual void GetGroupIDs(CAtlArray<GROUP_ID> & ids) = 0;
virtual IGroupModelPtr GetGroup(GROUP _ID id) = 0;
virtual GROUP_ID GetGroupFromIndex(UINT index) = 0;
virtual void RefreshAllGroups( ) = 0;
virtual IGroupModelPtr GetAllGroups( ) = 0;
virtual int GetGroupIndexFromID(GROUP_ID id) = 0;
virtual int GetGroupCount( ) = 0;

};
typedef boost::shared_ptr<IGroupListModel> IGroupListModelPtr;

APPENDIX C
class IGroupListController
{
protected:

virtual -IGroupListController( ) { };

public:

virtual GROUP_ID AddGroup( UINT index = 0xFFFFFFFF ) = 0;
virtual void DeleteGroup( GROUP_ID id )= 0;
virtual void MoveGroup( GROUP_ID id, UINT newIndex )= 0;
virtual void RestoreExistingGroup( GROUP_ID id, UINT
iInsertionIndex )= 0;
virtual void GetGroupIDs(CAtlArray<GROUP_ID> & ids)= 0;
virtual void SetGroupTitle(const CAtlString & title,
GROUP_ID id) = 0;

};
typedef boost::shared_ptr<IGroupListController>
IGroupListControllerPtr;

APPENDIX D
class IPageGroupView
{
public:

virtual void InvalidateArea(const RectF & rect) = 0;
virtual void NotifyCloseView( ) = 0;
virtual void LayoutChange( ) = 0;
virtual RectF VisibleDisplayArea( ) = 0;
virtual void SetScrollBarPosition(int x, int y) = 0;
virtual PointF ScrollBarPosition( ) = 0;
virtual PointF MaximumScrollPos( ) = 0;
virtual void InvokeGroupRightClickMenu(const PointF & pt,const

GROUP_ID & id) = 0;

virtual void InvokePageRightClickMenu(const PointF & pt, const

PAGE_ID & id) = 0;

virtual void StartPageTitleEditing(const RectF & rect, const
PAGE_ID & id) = 0;
virtual void StartGroupTitleEditing(const RectF & rect, const

GROUP_ID & id) = 0;

virtual void StartAutoScrollTimer( ) = 0;
virtual void StopAutoScrollTimer( ) = 0;
virtual ~IPageGroup View( ) { };

};
class CPageGroupView
{

CPageGroupView(const INotebookDocumentPtr & pDoc, const

IGroupListModelPtr & model, IPageGroupView* pgView);

~CPageGroupView( );
void OnPaint(const SDGraphicsContextPtr & g, const RectF & rect);
void OnLButtonDown(PointF pt, int nflags);
void OnRButtonDown(PointF pt, int nflags);
void OnLButtonUp(PointF pt, int nflags);
void OnKeyDown(UINT Key, UINT flags); // use the cross platform

keys here

void OnLButtonDblClick(PointF pt, int nflags);
void OnMouseMove(PointF pt, int nflags);
void InvalidateRect(const RectF & rect);
void OnDragging(PointF pt);
void OnDragEnter(const SDImagePtr & img, PointF pt);
bool OnDragStart(PointF pt, int nflags);
void OnDragLeave( );
bool HandleDrop(PointF pt);
void RemoveDragFeedback( );
void Layoutltems(const SDGraphicsContextPtr & g, const RectF &

rect, SizeF & scrollSize);

void initView( );
bool IfProduceRightClickMenu(const PointF pt);
void DeleteGroup(GROUP_ID id);
void MoveUpGroup(GROUP_ID id);
void MoveDownGroup(GROUP_ID id);
PageItemPtr GetDragPageItem( ) {return m_pItem;};
GroupItemPtr GroupAtPoint(PointF pt);
PageItemPtr PageAtPoint(PointF pt);
INotePageModelArrayListPtr GetSelectedNotePageModels( );
int GetItemFromPosition(GROUP_ID gid, PointF pt);
GROUP_ID GroupAtPosition(PointF pt);
PAGE_ID PageAtPosition(PointF pt);
bool IsDragFromSelf( );
void EndDragDrop( );
void EditGroupTitle(const GROUP ID & id);
void EditPageTitle(const PAGE_ID & id);
UINT NumberOfSelectedPages( ) const;
bool IsScreenShadeVisible(const PAGE_ID & id);
bool IsPageEmpty(const PAGE_ID & id);
void DeleteSelectedPages( );
void ClearSelectedPages( );
void ScreenShadeSelectedPages( );
void UpdatePage(const PAGE_ID & id);
bool IsRubberBanding( ) const;
void SelectedPages(CAtlArray<PAGE_ID> & ids);
void DoAutoScroll( );
IGroupModelPtr GetDragGroupModel( );
void CreateGroupFromSelectedPages(const CAt1String & title);

private:

IPageGroupView* m_pgView;

};
typedef boost::shared_ptr<CPageGroupView> CPageGroupViewPtr;

1. A software tool for organizing and manipulating an electronic document comprising at least one group of document pages, said software tool comprising:
a first user interface module configured to present the document pages of the electronic document in a list-like arrangement;
a second user interface module configured to present the document pages of each group in a respective panel; and
means operable to manipulate a plurality of selected document pages presented in one or more of said panels simultaneously.

2. A software tool according to claim 1 wherein said second user interface module is configured to permit document pages of each group to be re-ordered within said respective panel.

3. A software tool according to claim 2 wherein said second user interface module permits document pages of each group to be re-ordered via drag and drop operations.

4. A software tool according to claim 1 wherein said second user interface module is configured to permit document pages to be moved between panels.

5. A software tool according to claim 4 wherein said second user interface module permits document pages to be moved between panels via drag and drop operations.

6. A software tool according to claim 1 wherein said first user interface module is configured to permit the order of document pages in the list-like arrangement to be re-ordered.

7. A software tool according to claim 1 wherein said means operable to manipulate is configured to apply a theme to the plurality of selected document pages.

8. A software tool according to claim 7 wherein the applied theme is selected from the group comprising color, graphical objects, text, pattern, audio and video.

9. A software tool according to claim 1 wherein said second user interface module is configured to label each panel.

10. A software tool according to claim 1 wherein said second user interface module is configured to, in response to user input, create a new panel.

11. A software tool according to claim 10 wherein said second user interface module is configured to permit document pages of existing panels to be moved to a created new panel.

12. A software tool according to claim 11 wherein said second user interface module permits document pages to be moved from existing panels to the created new panel via drag and drop operations.

13. In a presentation software environment where presentation software that permits a document comprising a plurality of pages to be displayed and manipulated when executing on a computing device, the improvement comprising a grouping tool operable to group pages of the document and display the pages of each group and to manipulate selected pages of one or more groups.

14. An electronic document organization and manipulation method comprising:
displaying each group of electronic pages of a document in an individual panel on a graphical user interface;
providing a tool to allow a user to re-order pages in one or more panels and/or to move pages between panels; and
responsive to use of the tool, re-ordering and/or moving the pages appropriately.

15. The method of claim 14 wherein the re-ordering and/or moving is performed in response to drag and drop tool operations.

16. The method of claim 14 wherein said tool is responsive to user input to select a plurality of pages and to apply a theme simultaneously to the selected pages.

17. The method of claim 16 wherein during said applying, a theme selected from the group comprising color, graphical objects, text, pattern, audio and video, is applied to said selected pages.

18. A computer readable medium embodying a computer program for organizing and manipulating an electronic document comprising at least one group of document pages, said computer program comprising:
computer program code for presenting the document pages of the electronic document in a list-like arrangement;
computer program code for presenting the document pages of each group in a respective panel; and
computer program code for manipulating a plurality of selected document pages presented in one or more of said panels simultaneously.

19. A computer readable medium according to claim 18 wherein said computer program further comprises computer program code foe re-ordering document pages of each group within said respective panel.

20. A computer readable medium according to claim 18 wherein said computer program further comprises computer program code for moving document pages between panels.

21. A computer readable medium according to claim 18 wherein said computer program further comprises computer program code for re-ordering the document pages in the list-like arrangement.

22. A computer readable medium according to claim 18 wherein said computer program code for manipulating applies a theme to the plurality of selected document pages.

23. A computer readable medium embodying a computer program for organizing and manipulating an electronic document, said computer program comprising:
computer program code for displaying each group of electronic pages of a document in an individual panel on a graphical user interface; and
computer program code responsive to user input for re-ordering pages in panels and/or moving pages between panels.

24. A computer readable medium according to claim 23 wherein said computer program further comprises computer program code for selecting a plurality of pages and for applying a theme simultaneously to the selected pages.
